(19) United States
(12) Patent Application Publication
(10) Pub. No.: US 2003/0040363 A1
(43) Pub. Date: Feb. 27, 2003

(54) Entertainment internet/network site and contest method

(76) Inventor: Jonathan E. Sandberg, Denver, CO (US)

Correspondence Address: Francis A. Sirr, HOLLAND & HART LLP, P.O. Box 8749, Denver, CO, 80201, US

(21) Appl. No.: 10/200,347

(22) Filed: Jul. 22, 2002

Related U.S. Application Data
(60) Provisional application No. 60/314,485, filed on Aug. 23, 2001.

(51) Int. Cl. G06F 19/00

(52) U.S. Cl. 463/42

(57) ABSTRACT

An Internet/network game site is provided whereby site-users may spend digital tickets in order to compete in site-games having a prize that is awarded to the game winner. Site-visitors may become site-users by submitting user-identification that includes a credit card method of payment for the purchase of digital tickets. A site-user may thereafter purchase digital tickets after supplying site-user-identification, whereupon purchased digital tickets are recorded for the site-user, and whereupon purchased digital tickets are paid for using the specified credit card method. A plurality of site-games are provided to be played by site-users. A merchant may contribute a product/service having a stated monetary value as a prize for a game. The Internet site automatically increases this stated monetary value to a higher monetary value, assigns the prize to the game, and that assigns a number of digital tickets to the game so that a total monetary value of the digital tickets assigned to the game equals the higher monetary value. When a site-user elects to participate in the game, the site-user is charged a digital ticket monetary amount that is based upon the higher monetary value of the prize assigned to the game, and the purchased digital ticket quantity recorded for the site-user is accordingly reduced. The site monitors a number of digital tickets used to compete in the game, and terminates the game when a total monetary value of digital tickets used to compete in the game equals the total monetary value of digital tickets assigned to the game. A winner of the terminated game is determined, the prize is delivered from the merchant to the winner, and the merchant is paid a monetary value that is greater than the stated monetary value, but is less than the total monetary value of digital tickets assigned to the terminated game.

### CROSS-REFERENCE TO RELATED APPLICATION

This application claims the benefit of United States Provisional Patent Application serial No. 60/314,485 filed on Aug. 23, 2001 entitled eENTERTAINMENT INTERNET SITE AND CONTEST METHOD, incorporated herein by reference.

### FIELD OF THE INVENTION

This invention relates to a network such as the Internet and to a network site that provides a contest environment in which merchants may enter items/services/products, and in which site-users may enter a competitive contest or a raffle in an attempt to win the merchant's items/services/products.

### BACKGROUND OF THE INVENTION

An entertainment environment has been provided at carnivals, in taverns, and more recently in video arcades, whereby contestants are provided the opportunity to win prizes

### SUMMARY OF THE INVENTION

This invention provides an Internet site (sometimes called a World Wide Web site or a Web site), or a network site, that looks, feels and acts like an online, International, World's Fair/Carnival.

While the invention will be described in the context of the well known Internet, it is to be understood that the spirit and scope of the invention more broadly includes a network such as might be provided by a hotel and/or a casino which is constructed and arranged to provide the present invention.

The Internet site, or the network site, of the invention provides an online carnival, raffle or competitive game show environment. Site-users first purchase digital tickets or tokens (hereinafter tickets) in order to participate in events that are provided by the site.

Without limitation thereto, such events may include (1) competitive games of skill in which each game requires that a specified ticket monetary value be paid in order to compete in the game, wherein the game is completed when a specified number of participants have competed the game (i.e. a specified total monetary ticket value has been received), and wherein a prize is awarded to the winner of the game (and perhaps to runners-up), and (2) raffles requiring that a specified monetary value of tickets be paid in order to compete in the raffle, wherein the raffle is completed when a specified number of participants have competed the raffle (i.e. a specified total monetary value of tickets has been received), and wherein a prize is awarded to a winner by way of a chance-drawing (and perhaps to runners-up).

As used herein, the term game means a game or a contest of skill, or a game or a contest of chance, a raffle being a non-limiting example of a game of chance wherein a prize(s) is won by one (or more) of numerous people who enter the raffle.

In accordance with the invention, site-users may purchase tickets that can then be used to enter a raffle, a competitive contest or a competitive game of the site-user's choice. Without limitation thereto, the tickets that can be purchased may be of different monetary values. However, each game requires that the tickets paid to compete in the game be of a specified monetary value. For example, if a game's specified monetary value is one-dollar per play, a participant may pay-to-play using one one-dollar ticket, or four twenty five cent tickets.

Site-users are provided with a wide array of products/services for which he/she is able to compete. That is, the Internet/network site of the invention provides a web-like-place for site-users to buy tickets which can be used to competitively play an assortment of skill-games such as trivia games, word games, arcade games, strategy games, and various other games of skill. A site-user competes against other site-users in an effort to accumulate points or win tickets, and to win any number of prizes.

As a feature of the invention, each ticket that is purchased by a site-user results in one or more points being awarded to the account of the site-user. When a site-user has accumulated a relatively large number of such points, the site-user can use these points to purchase products/services from merchants who participate in the operation of the site.

As an additional feature of the invention, games of skill may be designated as amateur games of skill. When a game is designated as an amateur, the game is conducted in the above described manner, however when a game is terminated the prize of the game is not awarded to the high-scorer, rather the prize is awarded to the participant(s) having the mean-score.

At least three elements that are attractive to humans are used in the operation of the Internet site of the invention, namely Consideration, Prizes, and Skill.

The Internet/network site of the invention utilizes a pay-per-game (i.e. pay-to-play a game) model wherein site-users visit the Internet/network site of the invention in order to buy tickets that can then be used to enter competitive contests and to thereafter play competitive games that are presented by the site of the invention. Each competitive game is assigned a ticket monetary value that must be paid by a site-user in order to play the game, and each competitive game is assigned a number of competitors after which play in the game is terminated and a winner (or winners) is determined, that is a game is terminated after the total monetary value of the tickets “spent” by the participants equals a pre-determined monetary value.

### BRIEF DESCRIPTION OF THE DRAWING

FIG. 1 provides a showing of the various functional elements that make up the Internet/network site of the invention.

FIG. 2 shows a typical web-page frame layout that is provided for the Internet/network site of FIG. 1, this page layout having a header area, a drill-down menu system, and a current page-content portion.

FIG. 3 shows a number of Internet/network site functional components that create the Internet/network site shown in FIG. 1.

FIG. 4 depicts the generally screen layout of the players catalog shown in FIG. 3.

### DETAILED DESCRIPTION OF THE PREFERRED EMBODIMENT

This invention provides an Internet site (also known as a World Wide Web site or a Web site), or a network site, that looks, feels and acts like an online, International, World's Fair/Carnival wherein site-users digitally purchase tickets, which tickets may then be used to enter a raffle, a contest or a game of the site-user's choice, and on a pay-per-game basis, in order to win services, and/or products, and/or tickets.

The invention allows site-users to buy relatively cheap tickets that can then be used to play competitive games in an attempt to win relatively expensive goods/service, thereby combining a relatively small ticket price with a competitive contest of skill that may result in the winning of a relatively expensive prize.

Site-users are provided with excellent odds since a relatively valuable good/service may be won for a small monetary amount, such as a quarter, simply by playing and winning a contest against a relatively small number of other site-users. Thus, many small contests can be held on the Internet/network site of the invention during a given time interval, for example one contest can be held every second.

This invention increases the odds of winning by a site-user, while simultaneously allowing merchants to effectively sell merchandise, since fewer site-users are required to compete in a game in order to win a prize, when compared to free game sites wherein site-users must play against millions of other site-users for the chance to win an item such as a CD player, and with even worse odds when playing for a more expensive item.

In the practice of the invention, site-user fees are paid to the Internet site of the invention by selling tickets a relatively long period of time before it is necessary to pay merchants for goods/services that are won while playing competitive contests that are provided by the Internet site of the invention.

The method of the invention provides a means by which site-users are retained at the Internet site of the invention for longer periods of time than is currently possible because the invention creates a greater financial and time commitment by site-users. This in turn increases the ability to attract merchants and advertisers to the Internet site of the invention. Different strategies provide an Internet site of the invention that is fast paced and unique. Limiting the number of site-user participants in each contest provides a fast-paced, quick-reward, experience for the site-users.

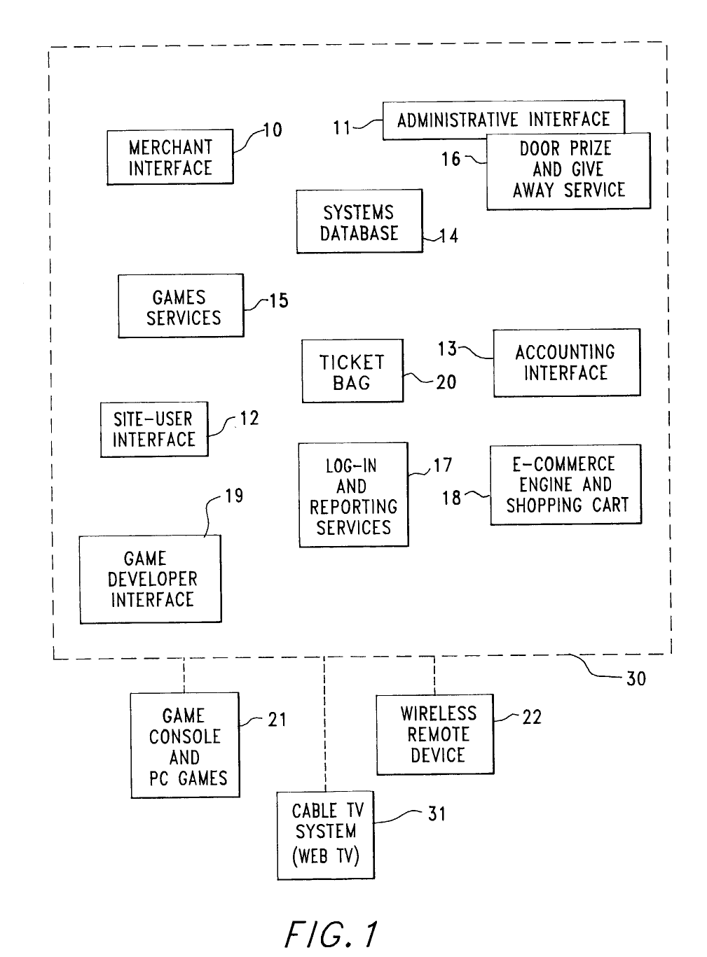

FIG. 1 provides a non-limiting showing of various functional elements that make up the Internet/network site 30 of the invention, comprising, without limitation thereto, a Merchant-Interface 10, an Administrative-Interface 11, a Site-User-Interface 12, an Accounting-Interface 13, a Systems Database section 14, a Games Services section 15, a Door Prize and Give-Away Services section 16, a Loggin and Reporting Services section 17, an E-Commerce Engine and Shopping Cart section 18, a Game Developer Interface 19, Ticket Bag 20, one or more game consoles 21 that are connected to Internet/network site 30, one or more wireless remote devices 22 that are connected to Internet/network site 30, and one or more cable TV systems 31 that are connected to Internet/network site 30.

Merchant-Interface 10 provides a facility for merchants to offer products and/or services that can be won as prizes as site-users interact with Internet site 30, or that can be purchased by site-users with points that they have accumulated by buying tickets from Internet site 30. Site-users can use Site-User Interface 12 to digitally purchase tickets, and such tickets can also be won by site-users as prizes in relation to a large number of online-contests that are provided by the Internet site 30 of the invention. The account of a site-user is awarded points with each ticket purchase, and these accumulated points can be used to buy products/services from site merchants.

Merchant-Interface 10 resembles an online auction site that allows merchants to upload any number of products or services to Internet/network site 30 of the invention. Merchants use Merchant-Interface 10 to sell products/services, to donate products/services, and/or to enter products/services as prizes in contests that are provided by Internet site 30. In doing so, the merchant's services/products are usually “sold” for more than their current retail price.

For example, assume that a merchant uses Merchant-Interface 10 to enter a $1,000 retail price mountain bike into a competitive contest that is provided by the Internet site of the invention. The merchant first uses Merchant-Interface 10 to set-up use of Internet site 30 by filling out an online form that is provided by Merchant-Interface 10.

The merchant chooses the ticket monetary value that the merchant wants to charge for entry into the contest (ticket monetary values may range from a one nickel ticket to play a game for smaller prizes, up to a ticket monetary value of a hundred dollars or more in order to play a game if the merchant's prize is a luxury car or a house/property). The merchant may also determine whether or not shipping will be charged for shipping the mountain bike to the winner of the contest, which of the Internet site contests the merchant wants site-users to play as they compete for the mountain bike, an ending date for the contest, etc.

In order to determine the total monetary value of the tickets that will be sold for this example contest, software provided by Internet site 30, for example in Games Services section 15, first increases (for example doubles) the retail dollar value of the mountain bike, and then divides this new dollar value by a chosen ticket denomination or monetary value (this financial model being adjustable).

In this example, assume that the merchant indicates that four 25-cent tickets are to be charged for entry into the contest. i.e. one dollar per contest entry. In this case, Internet site software, for example in Administrative Interface 11, first generates the figure of $2,000.00, based upon the $1,000.00 retail value of the mountain bike, and based upon the requirement that entry into the Internet site contest will cost $1.00 per entry, thus creating an Internet contest that seeks to sell 2,000 tickets. After 2,000 attempts at competing in the contest have been completed, using Site-User Interface 12, the game is terminated, and a winner is chosen by determining the site-user having the highest contest score (or the site-user having the mean contest score in the case of a game that is an amateur game).

When the winner has been determined, for example by Games Services 15, the merchant ships the winning site-user the prize, i.e. the mountain bike is shipped from the merchant to the winning site-user.

After it has been determined that the winner has received the prize mountain bike, using an automated software-driven process of the invention that follows tracking numbers, for example in Accounting Interface 13, the merchant's account in Accounting Interface 13 is credited with 110% of the stated value of the mountain bike, i.e. with $1,100.00, and Internet site 30 retains the remaining amount of $900.00 as profit for the Internet site.

As a feature of the invention, the site merchant may elect to have a charitable organization benefit from the game. When this is done, the site merchant identifies the charitable organization, site-users are notified that participation in the game will benefit the charitable organization, and the total monetary value of the tickets that are sold in order to terminate the game will be shared by the merchant, the Internet/network site and the winner of the game. Usually, but not required, the merchant in this situation again receives more of a monetary value than the retail monetary value of the prize. For example, in the above example of a $1,000.00 retail value bicycle wherein a total monetary ticket value of $2,000.00 is spent in competition in a terminated game, the merchant may receive $1,100.00, the Internet/network site may retain $600, and the charitable organization may receive $300.00.

The Internet site 30 of the invention provides that competition is fair among the competing site-users. For example, differences in a site-user's computer speed and Internet connection do not affect the playing-field of the contests, thus no one site-user has an advantage over another site-user.

The Internet site 30 of the invention provides a Contest-Developer-Interface 19 whereby contest developers can develop and then upload contests directly to the Internet site of the invention. This feature of the invention provides for the use of only the best online contests, while allowing contest developers to share in the profits of the Internet site, and to receive site-notoriety and site-exposure.

Administration of the Internet site and its Game Developer Interface 19 by Administrative Interface 11 provides that only acceptable contests can be uploaded to the Internet site by contest developers. In order for contest developers to contribute contests to the Internet site of the invention, a contest developer must meet criteria set forth in Game-Development-Interface 19.

As a method feature of the invention, known coin-op video game concepts are combined with the capabilities of Internet/network site 30. The Internet entertainment business method of the invention includes a stand-up remote version of a coin-op, video game like console 21 that is networked to Internet site 30, thus allowing site-users to play contests from remote locations such as bars, gas stations, family entertainment centers, etc. Thus, site-users can play contests while away from home simply by inserting quarters, dollars, or a credit card into a console 21, then sign up as a site-user (if not already a site-user), and enter and play contests just as if the site-user was at home. This feature of the invention provides for the sale, lease or license of the invention to the vending industry and/or the gaming industry.

In addition, and expanding upon the above-described method feature of the invention, third-party wireless/remote devices 22 can be used in conjunction with Internet/network site 30, examples of which are PDA's, cell phones, wireless laptops, and other such remote or wireless technologies, and in addition cable TV systems 31 may be associated with Internet/network site 30.

The invention combines Merchant-Interface 10 with a pay-per-game feature that is found in Site-User Interface 12, while providing contests that allow site-users to compete against each other to win prizes, and allows practically anyone (i.e. merchants) to sell items and/or services on Internet site 30.

As a feature of the invention, site-users may enter contests in which they may select to win tickets instead of winning individual prizes. The tickets that are won are then recorded to the account of the site-user, using Accounting Interface 13, and these tickets can then used to play future games on Internet site 30.

Merchants play a unique role in the Internet/network site of the invention in that merchants place goods and/or services on the site, often in high quantities, using Merchant Interface 10. Merchants then have the option to sell, to donate, or to enter these goods/services into a contest that is offered by Internet site 30, and in this manner the merchants' goods/services are offered to site-users. A site-user may then use purchased or won tickets to engage in games of skill or chance that may result in either winning a good/service that is offered as a prize, or may result in winning tickets that can then be used to play future games that are offered by the site and the site merchants.

Accounting Interface 13 provides that funds that are collected for tickets that are sold to site-users are shared with site merchants, thereby netting the merchants a higher than usual sales price (for example, 110% of the usual sales price), while in some cases also covering the costs of shipping goods to a site-user. In addition, Merchant Interface 10 offers site merchants various marketing and advertising plans that allow site merchants to become well recognized by the Internet's community of site-users. Merchants may also designate that a charitable organization may also profit from a game that is offered by the Internet/network site.

Business strategy solutions are available for merchants placing items on the Internet/network site of the invention. Merchant Interface 10 helps site merchants promote products/services, describes how to best display products/services, and provides guidelines for games and skills that favor a merchant's particular type of product/service.

Choosing the monetary-value of tickets that must be used to participate in a game/contest provides for a profit to both the site merchants and Internet/network site 30, and perhaps to a charitable organization, while keeping the number of site-users that participate in any given game/contest relatively low, thus making the Internet/network site of the invention attractive, rewarding, and fun, creating good odds for site-users, and producing more winners, thus encouraging return visits to the site.

Due to the wide range of prizes that can be placed on Internet/network site 30 using Merchant Interface 10, a level of control is provided to site merchants. This control by site merchants includes items such as, selecting ticket dollar denomination to participate in a game, selecting skill contest types, and selecting a duration of play, thus promoting a better fit of goods/services to a site merchant's experience.

Internet/network site 30 of the invention provides the capability of (1) purchasing tickets, using Site-User Interface 12 and Accounting Interface 13, (2) providing products/services to be placed in an Internet/network site contest or game, using Merchant Interface 10, (3) collecting tickets when a site-user indicates a desire to participate in a given site contest, using Site-User Interface 12 and Accounting Interface 13, (4) administrating skill-based contests/games that are offered to site-users wherein the contests and games are both internally developed and are contributed by outside users, and wherein outside users can contribute skill-based games using an upload capability that is provided by the Internet site, using Administrative Interface 11 and Game Developer Interface 19, (5) scoring a skill-based game after a site-user has finished the game, using Games Services 15, (6) keeping track of site-users that have participated in each skills contest, using Loggin and Reporting services 17, (7) awarding a prize or tickets to the site-user who scores the best in each skills contest, or who scores a mean score if the game is designated as an amateur game, using Accounting Interface 13, Games Interface 15, and Ticket Bag 20, (8) resolving site-user score ties, as may be necessary, using Administrative Interface 11, (9) promoting items that are placed on the Internet site via merchant advertising, using E-Commerce Engine and Shopping Cart 18, (10) allowing merchants to register products/services for upcoming Internet contests, using Merchant-Interface 10, (11) providing site pages for the purpose of establishing site policies, rules, and status information, using Systems Database 14, (12) a section of the Internet/network site is dedicated to not-for-profit organizations, using Systems Database 14, and (13) Game Developer Interface 19 allows others to contribute games that may be selected and used as contests within the skills competition area of Internet/network site 30, wherein contributors of games that are selected may be rewarded for their contribution.

Site-users and merchants are generally the two types of individuals that utilize or come-to Internet/network site 30 of the invention, and site 30 provides varying services and capabilities to these different types.

Walk-on-users are site-users that visit Internet/network site 30, but are not at that time recognized by site 30. Walk-on users are generally first-time visitors, or returning visitors that for various reasons cannot be identified by the site For example, a site-user may not be initially identified when using someone else's computer to visit Internet site 30, or when the site-user has never accessed Internet site 30 from his/her current computer location. Walk-on-users can browse much of Internet site 30 without requiring that a userlogin be provided. A walk-on user cannot, however, purchase tickets and play contests/games without first providing a basic level of information to Internet 30, for example by using Loggin and Reporting Services 17. Once a walk-on user has entered information that allows him/her to be recognized by site 30, he/she then becomes a site-user. User information that is required includes, but is not limited to, “Name,” “Credit Card Number,” “Credit Card Expiration Date,” “Login ID”, “Password”, and acceptance of the terms of Internet site usage. This user information is then stored in Systems Database 14 for future use

Site-users are pay-tickets-per-game players on Internet/network site 30 whose user information is known by Internet site 30. Site-users must use tickets that are recorded in Ticket Bag 20 in order to participate on site 30. With the consumption of tickets, participation in the site's skills contests is allowed, for example by using Games Services 15. A site-user must have identified himself/herself to site 30 before he/she can purchase tickets and/or use the site's Ticket Bag 17. Site-users have the ability to visit all pages of the site that are available to site-users on site 30, which pages are stored in Systems Database 14. Site-users are not allowed access to Merchant Interface 10 or Administrative Interface 11. Only site-users have the ability to be entered in the site's Door Prize and Give Away Services portion 16.

Merchants can also be site-users, and can play competitive games on Internet/network site 30. However, when merchants wish to be recognized as site-users, they must supply the above-listed information that is required of all site-users, including a site-user ID, method of payment for tickets information, and a site-user password. When recognized as site-users, merchants do not receive special consideration on site 30, nor are they recognized as being associated with Merchant Interface 10. Merchants may access Merchants Interface 10, thereby allowing a merchant to add products/services to the Internet site, to upload information and pictures about products/services, and to set up information profiles for products/services. Merchants may not access Administrative Interface 11.

The nature of Internet/network site 30 of the invention requires that a site-user feel secure when using the site. In addition, a site-user may have purchased tickets that may not have been all used in a single site session. Such unused tickets are preserved for the site-users in Ticket Bag 20 between site sessions by site-users.

The ability to carry unused tickets within Ticket Bag 20 from one site game session to another requires that the site-user's account in Accounting Interface 13 be maintained in a safe and reliable manner. In this way, site 30 prevents fraud and other intrusions that might allow someone other than a particular site-user to use tickets that have been issued to that particular site-user. For this reason, a site-user login and identification process is used and stored in Systems Database 14 and/or Loggin and Reporting Services 17. Both consumers and merchants must have such a valid login and password to access the site.

As a site-user arrives at Internet/network site 30, by way of Site User Interface 12, he/she must be recognized by an ID and by a password. If a site-user cannot remember his/her password, he/she may request that the password be sent to his/her e-mail address. The e-mail address must have been entered in, and later matched within, that site-users account information that is stored in Accounting Interface 13, before the password can be sent to that site-user by way of e-mail. If requested by the site-user during registration, or if later entered by editing the site-user's profile stored in Loggin and Reporting Services 17, a familiar word and/or a reminder phrase may be established to verify the identity of any site-user requesting login information.

A security section of site 30 displays a complete description of the security measures that are in place to protect site-users' credit card and personal information.

A transaction-based Accounting Interface 13 is provided to track all transactions that are made by site-users and merchants. Information in Accounting Interface 13 not only includes how the site-user spent his/her tickets, but also includes information about a site-user's current IP address and other system-level information. This information is useful if and when a fraud charge must be investigated. Site-users are able to review their transactions that are contained in Accounting Interface 13 at any time.

A feature of the invention offers site-users extra security and fraud protection. A site-user is provided with the ability to limit access to his/her account from a certain IP address (i.e. from a certain computer). This option prevents access to the Internet site unless the site-user is at a specific physical location (i.e. at a specific IP address), or is using a specific computer. These choices are given to the site-user in simple terms such as “Select here to allow using your account from anywhere” or “Select here to restrict use of this account to your current PC”.

Games Developer Interface 19 of Internet/network site 30 offers a site-user the ability to upload games for review by the site's human Game Selection Board. Games are reviewed and potentially selected for use in Games Services 15 of site 30. Games are selected based on appropriateness on the Internet site for his/her work, as well as by other means as may be defined by the Game Selection Board. Game contributors may also be selected for a Best-Contribution award, as well as by other recognition.

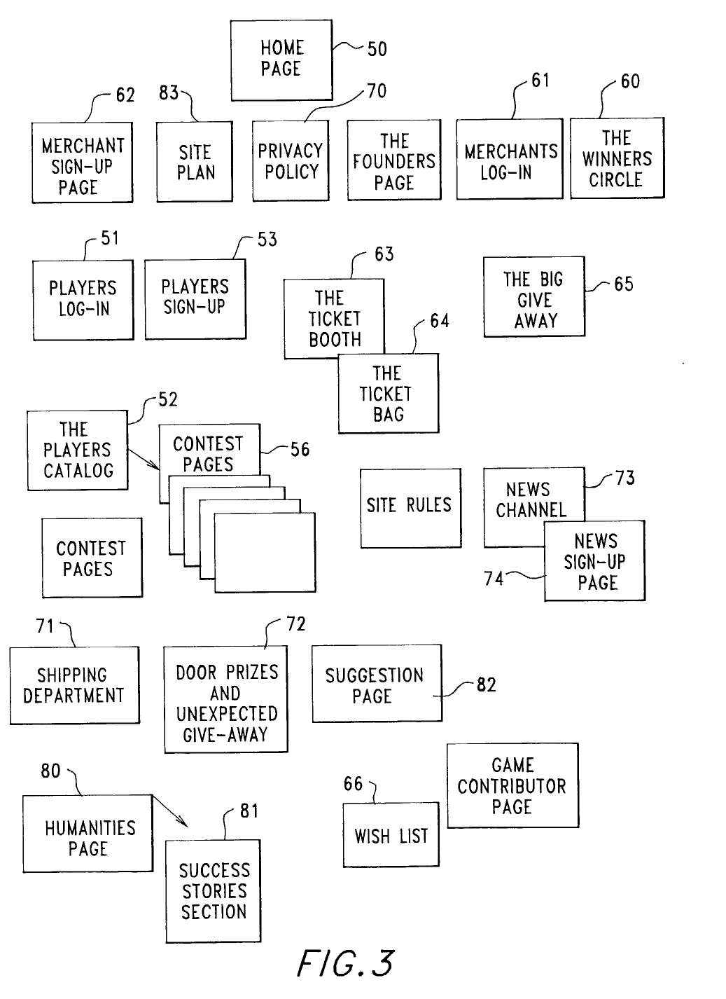

A Not-For Profit Section of Internet/network site 30 (see 80 of FIG. 3) is dedicated to the benefit of humanity, and displays appropriate designations that are needed for a not-for-profit Internet/network site. This section of the site provides the opportunity to ask for help by entering a story online. Pictures and references may accompany the story, such that a reviewer can understand detail relative to the need, and can then provide help if desired. Requests for help can be cataloged by need and then filed. A requester may check on the progress of the Internet site to determine the number of visitors and to obtain notes and messages that are left by visitors for the requester. These notes may ask for clarification or may make suggestions that are intended to help the requester's cause. An area of the Internet site's Not-For-Profit Section is set aside for recognizing success stories (see 81 of FIG. 3) that were caused by operation of this section of the Internet/network site of the invention.

A consistent web-page layout strategy is provided for Internet/network site 30 of the invention Use of a consistent system of page frames provides site-users with a level of confidence that they are capable of easily using site 30, and in addition the use of consistent page frames allows Internet site 30 to provide consistent navigation that spans several moves around the site.

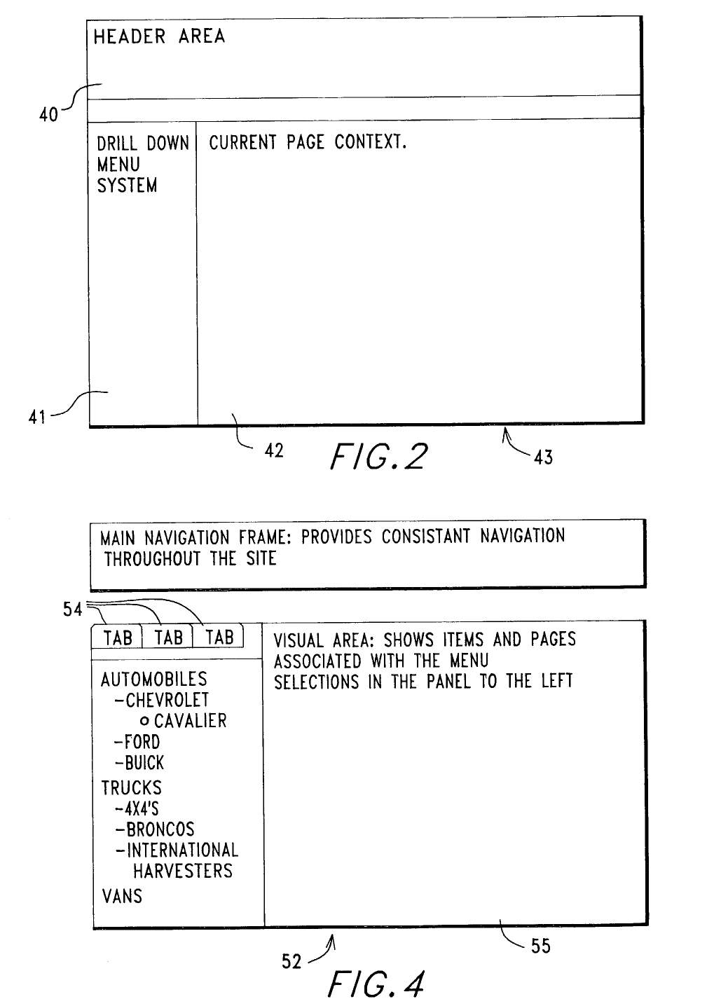

This web page layout strategy of site 30 is shown in the typical page frame 43 of FIG. 2, wherein reference number 40 designated the frame's header area, wherein reference number 41 designates the frame's drill-down menu system, and wherein reference number 42 designates the frame's current page-content.

Header area 40 provides for standard Internet site navigation. This area is used to move about Internet site 30 in large steps, and this area includes easily identified tabs and menu choices that are clearly labeled and easily accessible.

Drill-down menu area 41 expresses the context of the currently active area of Internet site 30. A site-user can use menu area 41 to drill directly into a particular area of Internet site 30 that is of interest to the site-user, for example “Travel->Areas->Florida”.

Current page-content portion 42 holds most pages, and typically represents a page that a site-user uses to hold currently selected game pages and scoring/playing rules for a selected game.

There may be situations where the above-described page strategy is not entirely satisfactory. In those situations, a page strategy is provided that accomplishes needed goals most effectively, and in these situations techniques are used that are consistent with the above-described page strategy.

A number of Internet/network site components are provided in order to create a fully-functional site 30 These components work together to produce the above-described Internet site effects and capabilities. These site components are shown in FIG. 3. The components shown in FIG. 3 are not intended to represent Internet web pages. Rather, they represent key systems within Internet site 30. The visual interface that is provided by a component of FIG. 3, the level of interactivity of the components of FIG. 3, and many aspects of the components of FIG. 3 vary from component to component.

Each component depicted in FIG. 3 represents an interface component. The visual design of these components usually differs from one component to the other in order to accommodate different needs of site-users at each interface.

A page overview section of site 30 (for example as shown in FIG. 4) describes concepts that are to be established for each key page in the site map shown in FIG. 3 Other pages may be mentioned from time to time that are not depicted in the site map of FIG. 3. However, this does not indicate that these are missing pages, but rather that these pages are not considered to be significant to the overall operation of site 30. For example, message pages, error pages, or other simple pages can be assumed to be a part of site 30, but their specific design does not affect the over all capability or usefulness of the Internet site. In Internet/network site 30 of the invention it is not uncommon to have a dozen or more pages of this type.

Home page 50 appears when a site-user first enters the address of site 30, for example an address such as “www.UncleBetty.com”. Home page 50 is identified to the Internet/network server (not shown) as the startup page when no specific page is requested. Home page 50 represents the primary starting point for site 30. Several other pages may act as entry pages to site 30, however, home page 50 is the default page.

From home page 50 a site-user can navigate to any given page within site 30, given that site 30 determines that the site-user is authorized to be a site-user having access to that given page. Typically, procedures are described in the Site-user's definition for the various site-user types that are supported by the UncleBetty.com site. Site-users are always able to return to home page 50 when desired

Home page 50 may change from time to time, as is required to accommodate promotions and events, and as is required to provide access to new sections of Internet site 30.

Home page 50 provides a method for known site-users to identify themselves to site 30. In order to access an account, a site-user must log in and provide a password. Home page 50 may not be an SSL secure page. However, a site-user is presented with an SSL secure page for login. Use of SSL prevents snooping, theft of site-user information, and unauthorized use of a site-user's account. Each site-user is responsible for the external use of his/her password(s) and account information.

Home page 50 is structured primarily to attract new site-users to play games offered by site 30. Most of the usable area of a computer display screen that is provided by home page 50 is formatted to allow site-users to see current winners, to see total dollars won to date, and to see other excitement-oriented information, such as pictures, and testimonials that will encourage site-users to pay-and-play games/contests on Internet site 30. A great deal of attention is paid to detail to ensure that home page 50 is exciting and appealing to the eye. Home page 50 is upbeat, and provides a circus or casino type atmosphere. Heavy use is made of flash type technology. (Flash is trademarked software from Macromedia.) Flash type technology creates very flashy and high motion interfaces. Flash movies are provided as is needed.

The use of Java Script on home page 50 provides a high utility interface, without the need for making multiple requests back to the Internet/network server. Java Script is a programming language that can be executed by the site-users' browser. There are multiple advantages to this technique. Java Script provides highly interactive menus and action on the site-user's local computer without requiring multiple round trips to the Internet server, thus reducing bandwidth and system resource requirements.

Player's login page 51 of FIG. 3 allows a site-user to come to the UncleBetty.com site and identify himself/herself to the Internet site. Security that protects site-users from fraud is description above. Player's login page 51 is a separate page because it is SSL security protected. Player's login page 51 is simple, and it provides a small amount of page-content, due to the high demands that are placed on the Internet/network server.

A site-user simply clicks and enters his/her information, and logs into site 30 using page 51. If the site-user cannot remember his/her password, the site-user may request that site 30 provide the forgotten password. As described above,'the site-user is then prompted for his/her e-mail address, and the e-mail address that is then supplied by the site-user must match the e-mail address that is associated with the site-user's account as stored in FIG. 1. If other security measures don't prevent it, the site-user's password and account information are then e-mailed to him/her on request. Additional security measures may be implemented as required.

Once a site-user (player) is logged into site 30, he/she is immediately transferred to players' catalog page 52.

Players' signup page 53 provides a means whereby a site-user can sign up for an account on the UncleBetty.com site, i.e. on site 30. This sign up process is streamlined, and does not requiring an excess amount of information from the site-user. An assumption is made that the site-user already has made the decision to sign up before arriving on page 53, and thus a simple registration process encourages participation in site 30.

Players sign up page 53 collects needed information from the site-user and allows the site-user to set profile options regarding his/her account. For example, the site-user might choose to have site 30 remember his/her credit card number(s). Players sign up page 53 also ensures that a site-user has the opportunity to read and accept site-use requirements When a site-user has successfully completed signing up for an account, site 30 of FIG. 1 generates an account number. The site-user then chooses a login ID and a password, which the system of FIG. 1 confirms, validates and resolves by way of duplicate entries. All of these actions are completed on secure page 53, thus insuring that both site-users and site 30 are not exposed to fraud. E-mails are generated when appropriate. The site-user is then offered the opportunity to go directly to login screen 51 and login to site 30.

When the site-user has successfully logged into site 30 one time, the site-user's account is validated. If an account is not validated in a given number of days, the system of FIG. 1 auto-generates an e-mail to inquire as to the reason for not validating the account, and encourages the site-user to spend his/her UncleBetty Tickets.

Players catalog page 52 is the primary interface page for a site-user. This page provides simple and quick access to all areas of site 30 that are available to a site-user. This page provides the site-user with any and all navigation that is needed to buy tickets, to find and select contests, to participate in contests, and to view and collect prizes.

The structure of players catalog page 52 provides quick access to both merchandise and contests that are of interest to a site-user. The use of drop-down menus and search options allow a site-user to quickly identify merchandise and contests.

Specifically, players catalog page 52 provides a categorized menu system along the left panel of the page, this being consistent with the page strategy shown in FIG. 2. This menu system allows a site-user to visually select a gross category area, and then see the drop-down menu for that gross category area along the left panel.

FIG. 4 depicts the general screen layout of players catalog 52.

With reference to FIG. 4, tabs 53 along the top of the navigation menu allow a site-user to select broad categories. Examples of broad categories are “Active Raffles”, “The Fast Lane”, “View by Products”, and “View by Active Raffles” etc. List 54 to the left shows items that are appropriate to a category that is selected.

In addition to the menu structure of FIG. 4, the site-user is able to select various search options. When a search option is chosen from the visual area 55 of the FIG. 4 screen, a search page is shown that allows site-users to search for items in site 30 based upon “Product”, “Game type”, “Best Odds” etc.

The nature of catalog page system 52,56 of FIG. 3 may require constant change. Changes are based upon current games in process, the type of game, the expressed interest of site-users, etc. Factors such as this require that pages 52,56 be constructed using highly interactive and dynamic design techniques. The design approach is data-description-language (DLL) based active-server-page (ASP) generation. Using these techniques, a highly interactive, constantly changing, menu system is provided that takes the site-user's interest into account. In addition, visual aspects of Internet site 30 are largely uncoupled from programming logic that provides interactivity. Menus and options are established by querying a database that is maintained using FIG. 1's Administrative Interface 11. This database holds information that is used to produce menus, such as “active games”, “the products database”, and “Winners”. Other information is added to the database as consumers participate in competitive games.

A primary goal of players catalog page 52, as shown in FIG. 4 is to draw site-users into selecting and participating in a competitive game Menus are simple, easy to understand, and they offer various ways to entice the site-user into making his/her selection. During the time that a site-user is searching through the menus, the visual area of players catalog page 52 displays information that may help to persuade a site-user into making a choice to pay-and-play. A variety of information is provided, such as the status of a game in process, total dollars won (i.e. the dollar value of prizes and/or tickets won) to date for this game, or simply a graphic or visual effect that dramatizes the particular game. Examples such as “The Mind Bender”, “The Fast Lane”, or other catchy names may be assigned to the menus and depicted in the visual area of the screen using graphics that support the graphics-idea.

Once a site-user has selected a competitive contest, he/she is routed to that contest's contest-page, allowing participation in the contest. A site-user may return to players catalog page 52 as often as desired in order to choose another contest.

In many cases, it may be desirable to enter an attract loop that provides a moving visual effect and/or sound that begins in situations where a site-user delays too long at a single spot within site 30. An attract loop is intended to be attention grabbing, with high flash and glitter, including movement on the site-user's computer display screen. Such an attract loop helps to catch the site-user's attention, and promotes staying with Internet site 30. The action that is provided may include the use of advertisements from the Merchants Interface 10 of FIG. 1. For example, various graphics from Merchants Interface 10 can be used to promote a merchant's products. Graphics can be splashed, pixilated or wiped onto the site-user's display screen in order to attract attention.

Winner's circle page 60 provides a way for site-users to see their name in lights. Winner's circle page 60 allows a site-user to see a page, generated by his/her computer, that shows winners, using splashy, high glitz, display methods. Colored circles are used to depict the levels of winners. For example, a Golden Circle would contain a list of the top ten highest dollar winners. Handles may be used when a winner indicates a desire to protect his/her privacy by not using the actual site-user's name. Dollar amounts and dates won appear along with the winner's name or handle and home state. In this circle, the value of the products won serves as the way to calculate total winnings. A Silver Circle can be used to show the most frequent winners. This provides site-users playing only small games a chance to be seen in the Winner's Circle. A Bronze Circle can be used to show the most frequent runners up. Additionally, winner's circle page 60 is used to display other non-consumer specific information, such as total dollars won today on the site and current winners per hour. Page 60 is very dynamic and potentially changes each time a site-user accesses page 60.

Merchant loggin page 61 provides a series of screens that allow a merchant to establish one or more products on Internet/network site 30. Each merchant can access his/her personalized area of site 30 using a secure log in ID and password. Merchants sign up for the “UncleBetty.com” site 30 using a merchant sign-up page 62, this page being a link on the main “UncleBetty.com” home page 50. Merchant sign-up page 62 is a secure page, thus protecting information provided by the merchant. Merchant sign-up page 62 is a non-burdening page, meaning that page 62 is simple to fill out and is user friendly. Requests for information are kept to a minimum. If additional details are required, the merchant is asked to provide the information as needed. The goal is to put the merchant at ease with site 30 and to offer a non-intrusive environment. Once a merchant has been provided with a login ID and password, the merchant may access Merchant Interface 10 of FIG. 1, which is designed in such a way as to make the merchant feel as if site 30 knows the merchant. Providing visual feedback and queues that clearly identify the fact that the merchant is known to site 30 facilitates this function and promotes a feeling of security for the merchant.

A merchant under no circumstances is able to see or obtain information regarding other merchants on site 30, unless specifically intended by the design of site 30. For example, it may be desirable to show summary data for all merchants, but never to show information of a proprietary nature regarding any merchant.

Ticket booth page 63 provides a way to interact with the FIG. 1 E-Commerce Engine and Shopping Cart 18 of Internet/network site 30. Page 63 is basically a card that acts as the name implies in that ticket booth page 63 allows a site-user to purchase tickets. Ticket booth page 63 is designed to allow site-users to buy tickets having various dollar values. In order to allow a site-user to participate in contests that have varying ticket values, the concept of different value tickets is desirable. For example, the denominations can be set up as, N Ticket value=1 nickel, D Ticket value=1 dime, Q Ticket value=1 Quarter, and E Ticket value=1 dollar. This method is flexible and can vary. An interface within FIG. 1's Administrative Interface 11 allows the system administrator of site 30 to select desired denominations for any given activity on site 30.

A primary goal of the ticket booth page 63 is to sell tickets to site-users in varying monetary denominations. This operation is simple and easy, while allowing the site-users to visually see what tickets are already in his Ticket Bag 64. Ticket Booth Page 63 provides a function of accepting credit card information and processing the credit card. Ticket sales made from the screen of ticket page 63 are final.

Ticket booth page 63 makes it easy for the repeat purchasers to make purchases. Having page 63 represent the last ticket purchase information accomplishes this function. The site-user may then edit choices and submit a new ticket purchase request.

The site-user is also allowed to indicate that he/she would like site 30 to remember his/her credit card. In this case, the site-user need only enter desired ticket quantity and dollar amounts in order for the ticket purchase to proceed. The site-user also has the option of indicating that he/she does not wish credit card information saved, in which case the credit card is remembered only for the duration of this one purchase. The site-user is then asked for a new card each time he/she makes another ticket purchase.

Ticket bag page 64 is a simple way for a site-user to look at his/her available tickets, wherein the tickets available include tickets that may have been won playing games on Internet site 30. Ticket bag page 64 also allows users to look-up the number of points that have been accumulated as tickets have been purchased. Ticket bag page 64 also offers easy access to ticket booth page 63 in order to facilitate the quick purchase of additional tickets. Another feature of ticket bag page 64 includes key statistics for site-user accounts wherein a site-user can view a list of his/her winnings for the last year, his/her standing with site 30, and any other information that may be appropriate about his/her account.

The use of tickets is an interesting and a convenient way to provide site-users with information regarding site 30. However, the design of site 30 affords site-users with short cuts for entering the amount of money needed to pay for a contest. In most cases, the amount is displayed on a content screen. The site-user is shown ticket bag page 64 when there is a need to replenish tickets.

Ticket bag page 64 is a pop-up page, it is small in size, and it visually depicts the idea of a ticket bag. Site-users can pop up ticket bag page 64 at any time without leaving his/her current location.

Ticket bag page 64 may include a cash out feature that allows a site-user to cash out unused tickets. Internet site 30 then generates a credit to the site-user for the amount of tickets remaining.

Big give away page 65 hosts freebie and Big Give Away programs. This area of site 30 often changes, based upon products and services that are donated by merchants. Criteria determine eligibility for page 65. Administrative Interface 11 of FIG. 1 is used to define criteria for site-users that are eligible for this section of site 30.

An administrator may designs pictures, graphics and text for a give away The next step is to select a type of give away option. Give away options could allow for “Free for all”, “Restricted to rules” or any other appropriate criteria. This criteria includes information such as when the give away will occur, as well as stating what factors will be used to give away the product. If desired, a give away item can be given away wherein all that a site-user needs to do is be present (on-line) in order to win. Whatever option is chosen, the same basic framework exists. As a feature, big give away Page 65 can include a list of past winners

A goal of FIG. 3's wish list page 66 is to encourage customers to participate in a contest. Wish list page 66 allows a site-user to identify items he/she would like to win. Wish list page 66 also serves as a connection between those who wish to give with those who wish to receive. Wish list page 66 has several basic elements, for example to establish what a site-user might want someone else to give the site-user, to find out what some other site-users might want, and/or to find a contest that would allow a site-user to get what the site-user wants for someone else. FIG. 3's privacy policy page 70 publicly states the policy on privacy of site 30. In recent years, consumers have expressed increasing concern regarding privacy and use of the Internet. As a result, Internet site owners and operators have become more sensitive to these issues. A clear statement of the position of Internet/network site 30 on this subject tends to comfort site-users, and helps to allay fears about disclosing information. Included below is an example of this policy. Our Commitment to You

UncleBetty.com is committed to providing the highest quality service and customer care. Respect for your privacy and security is part of our commitment to you, our loyal customer.

Information That We Collect and How it is Used (or Privacy Statement)

At UncleBetty.com we make every possible effort to provide you with a comfortable, private contest environment, which allows you to find and compete for products. To fulfill our service commitment to you, we may collect certain information from you, as follows:

Personal information such as c-mail address, name, mailing address, and age will be collected only when submitted voluntarily by you.

When you sign up to receive information from UncleBetty.com via e-mail, or submit a customer service request, we ask that you supply an e-mail address for our response. We will only request additional optional information that may allow us to better serve you.

When you play one of our raffles, we require your name, e-mail address (phone number if e-mail address is not available), mailing address, credit card number, and card expiration date. This allows us to process and fulfill your request and to notify you of any problems with your account status.

When you enter a contest or other promotional feature, we may ask for your name, address, and phone number so that we may administer the contest and notify the winners.

UncleBetty.com does not sell your personal information to others at any time for any reason.

Shipping department page 71 of FIG. 3 allows site-users to gain information regarding the shipment of products/services they have won Positive feedback is provided by page 71. Site-users are able to view the products/services that they have won, and they are providing with a sense of accomplishment and positive feedback. Shipping department page 71 provides the capability of (1) allowing a site-user to redirect a shipment to a location other than his/ her own location, wherein this can be done only before the product is shipped, (2) gaining access to tracking numbers that were used to ship his/her product/service, (3) gaining access to status information concerning a shipment, and (4) determining the ship-to address of the site-user's product/service.

Parts of shipping Department page 71 connect directly to a shipping provider's system, such as UPS or FedEx. For example shipping information may be entered automatically via a system administrative function of Internet site 30 as products/services are shipped.

FIG. 3's door prize and unexpected give away page 72 includes a set of pages (not shown) that are used to communicate the results of door prizes and unexpected give away of prizes. Typically, these pages appear at predetermined times during navigation of site 30. Examples of times when these pages appear include initial entry into site 30, and/or the starting or finishing of a contest on Internet site 30. Site 30 includes a site plan 83 of FIG. 3 having information that indicates where these pages appear. Door prizes and unexpected give away items are set-up using the FIG. 1 Administrative Interface 11.

In general, the design of the pages that are implemented in accordance with FIG. 3 are simple, they have a gala type appearance, and they including visual effects such as fireworks etc. These pages notify site-users of prizes and instructions for the claiming of prizes. The appearance and design of these pages promotes return visits to site 30.

News channel page 73 provides the latest news to site-users each time site 30 is visited, and also provides a way to sign up for extended information services. Newsworthy events are entered into Internet site 30, using FIG. 1's Administrative Interface 11. These events are then immediately available to the UncleBetty news channel 73. The format of page 73 provides for the display of a list of summary items consisting of a caption and a topic snippet wherein items are formatted down the page in descending date order. This allows more recent news to be at the top of the page. Formatting of the page includes a section 74 that provides information on signing-up for automated notifications.

Automated notifications presented in page 74 are set up using FIG. 1's Administrative Interface 11. Automatic notifications can take the form of e-mail notifications, News Letters, Microsoft News broadcast channels, and system icons.

Contest pages 75 provide a consistent contest environment for all site-user participants. A consistent set of controls are used by contestants in order to control the flow of a contest. Contest pages 75 are primarily Word-based, but other formats may be used. All contests are constructed using FIG. 1's Administrative Interface 11, thus ensuring that all contestants receive the same test for the same contest. All contests are administered in the same fashion. This lowers the risk of giving an advantage to one contestant over another.

All questions are stored and indexed within FIG. 1's Systems Database 14 A contest sheet (not shown) allows arbitrary questions to be compiled in order to form a contest, as a contest sheet is then assigned to each contest. Once the contest sheet has been assigned, all contestants are asked questions from that sheet.

Logic within contest page 56 is used to administer a contest. This logic constructs the contest, presents each question in a contest, and then grades the contest after it has been completed. This logic also records the results of each contest. The results are then recorded in Systems Database 14 of FIG. 1. This logic also enables site-users to review contest results to see how they rank against other participants. If a tie exists involving several site-users, the winner is decided by a random, computer-generated, selection.

Loggin And Reporting Services 17 of FIG. 1 provides statistical analysis that is needed to maintain Internet site 30. Services offered by area 17 of Internet site 30 include data that is captured by the web server. Information captured there focuses on a visitors' use of the site. Data captured includes visitor comments, errors recorded, and site functions that are most used. An administrative services portion of Internet site 30 that is within Administrative Interface 11 of FIG. 1 provides the ability to report on data that is captured by Loggin And Reporting Services 17.

Administrative Interface 11 of FIG. 1 includes programming that provides control over Internet site 30. Control features include managing site-users and accounts, managing merchants and accounts, as well as tracking and managing accounting functions. Some of the services provided for Internet site 30 by Administrative Interface 11 include (1) a Consumer Manager that audits and manages site-user accounts, wherein this feature primarily provides for the management of things that occur as exceptions, also including the capability of account management and research concerning a particular site-user, such as (a) manually adding a site-users account, (b) deactivating a site-users account, (c) re-instating a site-users account, (d) reporting on an account and Internet site 30 usage by a site-user, (e) reporting the winnings of a site-user, and (f) reporting the losses of a site-user.

FIG. 1's Merchant Manager 10 audits and manages merchant accounts and is primarily intended to handle things that occur as exceptions, and to also provide for account management and research concerning a particular merchant, including (a) manually adding a new merchant account, (b) deactivating a merchant account, (c) re-instating a merchant account, reporting account and site usage by a merchant, (d) reporting current products/services that are committed to site 30 by a merchant, (e) reporting a schedule of items committed to site 30 by a merchant, (f) and reporting the earnings of a merchant over a specified period of time.

A game management portion of FIG. 1's Administrative Interface 11 provides for the addition of contests and for the management of contests raffles. Using this tool site 30 can, (a) add a game to site 30, (b) create promotion text for a game, (c) create game questions for Internet site 30, assign questions to a game, (d) determine the scoring method to use in a game, (e) determine and enter tiebreaker methods for a game, (f) and make games available to merchants as choices when merchants enter products/services on site 30.

If a merchant does not associate a product with a specific game, programming automatically makes a game assignment for the merchant's product. A game management display screen that is part of Merchant Interface 10 provides for the selection of rules by which a game will be conducted.

Administrative Interface 11 includes a bank management area that provides for the selection of the dollar denomination of tickets. By entering dollar amounts here, ticket booth 63 of FIG. 3 automatically offers the options to site-users. This feature also ties into the Merchant Interface 10 so that a merchant can select a ticket dollar denomination to use for his product/service. If a merchant decides not to choose a ticket dollar denomination, site 30 calculates a dollar amount based upon a method specified on an administrative screen of Administrative Interface 11.

Accounting interface 13 of FIG. 1 automatically collects all information that is needed to manage the accounting needs of site 30, wherein accounting software performs the tasks of, (a) collecting transactions that relate to accounting, (b) providing dynamic reporting for site-users, including account status and auditing, (c) providing billing services that are needed to collect payment from site-users, (d) providing account reporting that is needed for auditing, (e) providing merchants with reporting that is needed to audit product/service won or sold, (f) providing information that allows company owners to assess profitability, (g) providing the ability to auto-settle accounts and provide statements that are needed for merchants, (h) and interact with credit card systems to issue debits, credits and adjustments as needed.

FIG. 1's door prize and give away services 16 provides a method to identify items for give away, provides for the specification of methods/rules for a give away, and provides for notification when a give away has been completed.

Database system 14 of FIG. 1 is based upon the Microsoft SQL Server 7.0 and provides a central place to record all data that is used by Internet site 30. The Microsoft SQL server is mirrored and is replicated as the size and the traffic of site 30 dictates. The SQL server is separate software from Internet site 30 and its Administrative Interface 11 software.

Web site service (not shown) is provided for site 30, and comprises hardware, software and communications services. The web site service used with the UncleBetty.com site 30 is Microsoft IIS 5.0 running on a Windows 2000 Server. Communications services are provided by UUNet and are based on a frame allocation system.

In an embodiment of the invention physical equipment and services to implement site 30 of the invention comprised a shared server site and included, (a) a site 30 that serviced from about 1,000 to about 1,500 concurrent site-users, (b) site 30 utilized one T1 communications channel that was shared by other low volume users, (c) and site 30 used a shared SQL 7.0 server capable of supporting from about 5,000 to about 10,000 concurrent site-users.

While the invention has been described in detail while making reference to preferred embodiments of the invention, it is recognized that others will, upon learning of the invention, readily visualize yet other embodiments that are within the spirit and scope of the invention. Therefore, the above detailed description is not to be taken as a limitation on the spirit and scope of the invention.

What is claimed is:

1. The method of providing a network wherein prizes can be won by participants who compete in competitive games, comprising the steps of:
providing a network-facility having plurality of competitive games that are played on a pay-per-game basis;
providing a network-facility whereby participants may purchase digital tickets for use in playing said games;
providing a network-facility whereby merchants may provide merchant-items to be offered as prizes in said games;
providing a network-facility whereby a merchant-item is assigned to each of said games, and whereby a total ticket monetary value is assigned to each of said games;
providing a network-facility whereby a participant elects to be a competitor in a given game by authorizing that a ticket quantity for said given game be subtracted from tickets purchased by said participant;
providing a network-facility for monitoring a total monetary value of tickets utilized in competing in each of said games;
providing a network-facility that terminates a game when a total ticket monetary value utilized in competing in a game equals a total monetary value of tickets assigned to said game;
providing a network-facility that determines a winner for terminated competitive games; and
awarding a merchant item to said winner.

2. The method of claim 1 including the step of:
paying a monetary amount to a merchant relative to a terminated game, said monetary amount being based upon a total monetary ticket value assigned to said terminated game.

3. The method of claim 2 including the steps of:
providing that a merchant submit a monetary value of a merchant-item; and
providing that a total monetary value of a ticket quantity assigned to a merchant-item be greater than said monetary value of said merchant-item submitted by a merchant.

4. The method of claim 3 wherein said monetary amount paid to a merchant is less than said greater monetary value and is greater than said monetary value of said merchant-item submitted by a merchant.

5. The method of claim 1 including the step of:
providing a network-facility whereby competitive games may be submitted for consideration to be included in said plurality of competitive games.

6. The method of claim 1 including the steps of:
providing a network-facility accounting for a quantity of tickets purchased by individual participants; and
reducing said quantity of tickets as individual participants compete in competitive games.

7. The method of claim 6 wherein tickets may be awarded to winners of competitive games, and wherein said awarded tickets are added to a quantity of tickets held in an account of said winners.

8. The method of claim 1 wherein merchant-items that are won as prizes are supplied to winners by merchants who provide said items.

9. The method of claim 8 including the steps of:
providing that a merchant submit a monetary value of said item,
providing that a total monetary value of a ticket quantity assigned to a game awarding said item is greater than said submitted monetary value of said item; and
paying a monetary value to a merchant providing an item to a terminated game, said paid monetary value being less than a total monetary value of a ticket quantity assigned to said terminated game and being greater than said monetary value of said item.

10. The method of claim 9 including the steps of:
providing a network-facility that tracks items won by winners as said items are shipped to winners by merchants who providing said items, and
providing a network-facility that accounts for a quantity of tickets purchased by individual participants, and reduces said quantity of tickets as individual participants compete in competitive games.

11. The method of claim 10 including the step of:
providing that participants are awarded points for the purchase of tickets; and
provided that said points may be accumulated in an account of said participants for use in purchasing items from merchants without winning competitive games.

12. The method of providing a computer network site wherein prizes may be won by site-users, comprising the steps of:
providing a site-facility having competitive games to be played by a plurality of site-users on a pay-per-game basis;
providing a site-facility whereby site-users digitally purchase tickets for use in playing said competitive games;
providing a site-facility that records tickets that are purchased by individual site users;
providing a site-facility whereby merchant-prizes are offered in said competitive games, said prizes having monetary values assigned thereto by offering-merchants;
providing a site-facility for increasing said assigned monetary values to a higher monetary value;
providing a site-facility for assigning prizes to said competitive games, for assigning a per-game ticket quantity to said competitive games, and for assigning a total quantity of competitors to said competitive games;
providing a site-facility whereby a site-user becomes a competitor in a given competitive game, as a per-game ticket quantity assigned to said given competitive game is subtracted from tickets recorded for said site-user;
providing a site-facility for monitoring a number of competitors who have competed in said competitive games;
providing a site-facility that terminates a competitive game when a number of competitors who have competed in a competitive game equals a total quantity of competitors assigned to said competitive game;
providing a site-facility that determines at least one winner for terminated competitive games;
providing that merchants supply merchant-prizes to at least one winner of terminated games; and
providing that merchants supplying merchant-prizes to terminated games are paid a monetary value that is greater than said assigned monetary value and is less than said higher monetary value.

13. The method of claim 12 wherein said merchant-prizes may be tangible products and/or intangible services.

14. The method of claim 13 wherein site-users are awarded points for said purchase of tickets, and wherein said points may be used to purchase said tangible products and/or intangible services.

15. The method of claim 12 wherein site-users are awarded points as tickets are purchased, and wherein said points may be used to purchase prizes from merchants.

16. The method of claim 14 including the step of:
providing a site-facility whereby competitive games may be submitted for consideration to be included in said competitive games.

17. The method of claim 14 including the step of:
providing to site-users a list of winners and/or prizes that have been won.

18. The method of claim 14 including the step of:
providing a site-facility whereby site-users may use tickets to purchase prizes from said merchants in the absence of competing in said games.

19. A method providing an Internet game site wherein site-users spend digital tickets in order to compete in site-games having a prize to be awarded to winners of said site-games, comprising the steps of:
providing a site-facility whereby site-visitors may become site-users by submitting user-identification information that includes a method of payment for purchase of said digital tickets;
providing a site-facility whereby site-users may purchase said digital tickets after supplying said user-identification, whereby purchased digital tickets are recorded for said site-user, and whereby purchased digital tickets are paid for using said method of payment,
providing a site-facility having a plurality of site-games to be played by site-users;
providing a site-facility whereby a merchant may contribute a product/service having a stated monetary value as a prize for a game;
providing a site-facility that increases said stated monetary value of said prize to a higher monetary value, that assigns said prize to said game, and that assigns a number of digital tickets to said game so that a total monetary value of digital tickets assigned to said game equals said higher monetary value;
providing a site-facility whereby site-users may elect to participate in said game, whereupon said site-users are charged a digital ticket amount that is based upon said higher monetary value of said prize assigned to said game, and whereupon said purchased digital tickets recorded for said site-users are accordingly reduced,
providing a site-facility that monitors a number of digital tickets used to compete in said game, and that terminates said game when a monetary value of digital tickets used to compete in said game equals said total monetary value of digital tickets assigned to said game;
determining a winner of said terminated game;
delivering a prize from said merchant to said winner of said terminated game; and
paying a monetary value to said merchant, said paid monetary value being greater than said stated monetary value and being less than said total monetary value of digital tickets assigned to said terminated game.

20. The method of claim 19 wherein said method of payment includes a method of payment for purchase~of said digital tickets is payment by credit card.

21. The method of claim 20 including the step of:
providing a site-facility whereby a site-user may elect to have a monetary value of digital tickets recorded for said site-user credited to a credit card of said site-user.

22. An Internet/network game site whereby site-users may use digital tickets in order to compete in site-games having a prize to be awarded to winners of said site-games, comprising.
a site facility whereby site-visitors become site-users by submitting user-identification information that includes a method of payment for purchase of said digital tickets;
a site facility whereby site-users purchase said digital tickets after supplying said user-identification, whereby purchased digital tickets are recorded for said site-user, and whereby purchased digital tickets are paid for using said method of payment;
a site facility having a plurality of site-games to be played by site-users;
a site facility whereby a merchant contributes a product/service having a stated monetary value as a prize for a game;
a site facility that increases said stated monetary value of said prize to a higher monetary value, that assigns said prize to said game, and that assigns a number of digital tickets to said game so that a total monetary value of digital tickets assigned to said game equals said higher monetary value;
a site facility whereby site-users elect to participate in said game, whereupon said site-users are charged a digital ticket amount that is based upon said higher monetary value of said prize assigned to said game, and whereupon said purchased digital tickets recorded for said site-users are accordingly reduced;
a site facility that monitors a number of digital tickets used to compete in said game, and that terminates said game when a monetary value of digital tickets used to compete in said game equals said total monetary value of digital tickets assigned to said game;
a site facility that determines a winner of said terminated game;
a site facility that requests said prize be delivered from said merchant to said winner of said terminated game; and
a site facility that pays a monetary value to said merchant, said paid monetary value being greater than said stated monetary value and being less than said total monetary value of digital tickets assigned to said terminated game.

23. An Internet/network game site whereby site-users may spend digital tickets in order to compete in site-games having a prize that is awarded to a game winner, comprising:
a site facility whereby site-visitors may become site-users by submitting user-identification that includes a credit card method of payment for purchase of digital tickets;
a site facility whereby a site-user may purchase digital tickets after supplying said site-user-identification, whereupon purchased digital tickets are recorded for said site-user, and whereupon said purchased digital tickets are paid for using said specified credit card method;
a site facility having a plurality of site-games to be played by site-users;
a site facility whereby a merchant may contribute a product/service having a stated monetary value for use as a prize in one of said games,
a site facility for automatically increasing said stated monetary value to a higher monetary value, for assigning said prize to said one of said games, and for assigning a total number of digital tickets to said one of said games so that a total monetary value of said digital tickets assigned to said one of said games equals said higher monetary value;
a site facility for enabling a site-user to elect to participate in said one of said games, for charging said site-user a digital ticket monetary amount that is based upon said higher monetary value of the prize assigned to said one of said games and for reducing said purchased digital ticket quantity recorded for said site-user;
a site facility that monitors a total number of digital tickets used to compete in said one of said games, and for terminating said one of said games when a total monetary value of digital tickets used to compete in said one of said games equals said total monetary value of digital tickets assigned to said one of said games;
a site facility for determining, a winner of said terminated game, and for directing that said prize be delivered to said winner; and
a site facility for direction that said merchant be paid a monetary value that is greater than said stated monetary value, but is less than said total monetary value of digital tickets assigned to said terminated game.

24. The Internet/network game site of claim 23 including:
a site facility for specifying that a charitable organization share in the profits of a terminated game.
